(19) United States
(12) Patent Application Publication
(10) Pub. No.: US 2011/0020665 A1
(43) Pub. Date: Jan. 27, 2011

(54) COATED METAL ARTICLE AND METHOD OF MANUFACTURING SAME

(75) Inventors: Daniel L. Serafin, Baden, PA (US); Ian A. McCallum, Pittsburgh, PA (US); Roger W. Kaufold, Pittsburgh, PA (US); Robert E. Bombalski, Pittsburgh, PA (US); Luis Fanor Vega, Cheswick, PA (US); Donald Robert Smith, Gibsonia, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignee: ALCOA INC., Pittsburgh, PA (US)

(21) Appl. No.: 12/664,556

(22) PCT Filed: Jun. 13, 2008
(86) PCT No.: PCT/US08/66820

§ 371 Date: Jul. 2, 2010

Related U.S. Application Data
(60) Provisional application No. 60/943,730, filed on Jun. 13, 2007.

(51) Int. Cl. C25D 11/04; C23C 28/00; B60B 19/00; B60R 19/03

(52) U.S. Cl. 428/629; 205/188; 205/190; 301/5.1; 293/102

(57) ABSTRACT

A surface finishing and coating methodology that provides a superior looking aluminum product with acceptable corrosion performance for outdoor use. In one embodiment, a coating of high purity aluminum is applied first to an aluminum article or product via cold or thermal spray and the mechanical surface modification (e.g., polishing, buffing, brushing, etc.) is clone second. The resulting product has the desirable light weight and mechanical properties of aluminum with the chosen look and performance of the high purity aluminum coating. The aluminum product to be coated may be obtained by extrusion, forging, casting, or rolling.

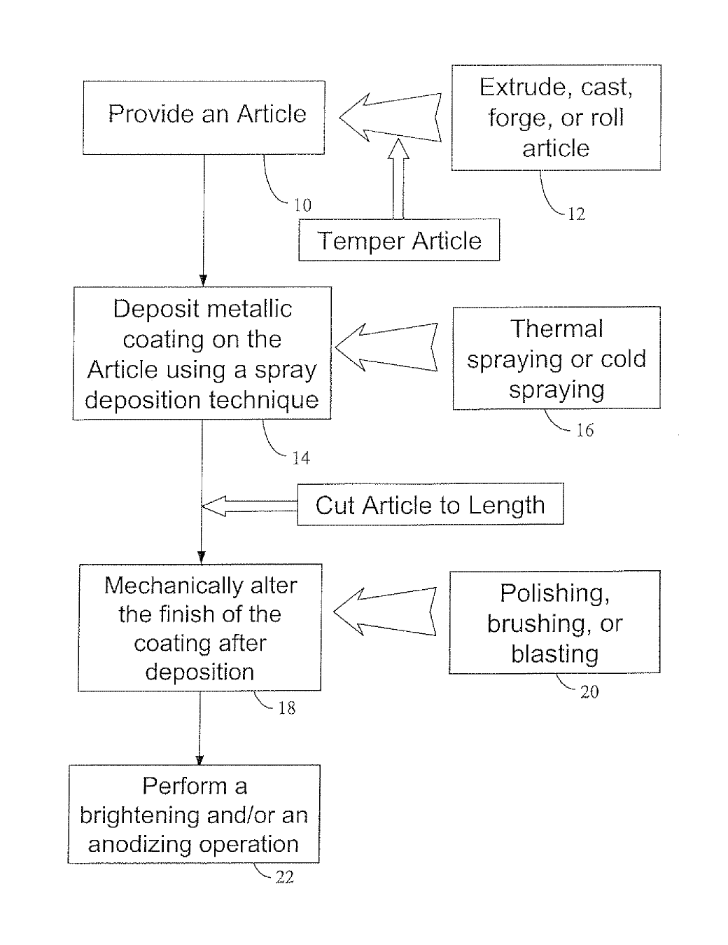

### CROSS REFERENCE TO RELATED APPLICATIONS

The present invention claims benefit of U.S. Provisional Application Ser. No. 60/943,730, entitled “ALUMINUM PRODUCTS WITH HIGH PURITY ALUMINUM COATING” filed on Jun. 13, 2007, which is incorporated herein by reference.

### FIELD OF INVENTION

In one embodiment, the present disclosure relates to coating metal articles.

### BACKGROUND OF THE INVENTION

Aluminum products or articles are used in a number of applications where light weight, mechanical strength, and thermal properties are essential factors. In many instances, an aluminum product is selected not only for its weight, strength, and thermal properties, but also for its physical appearance (i.e., finish) and durability. For instance, depending on the end use of the product or the preference of the target customer, the physical appearance of the aluminum product could be polished (i.e., bright or shiny) or matte or brushed.

### SUMMARY OF THE INVENTION

In one embodiment, the present disclosure relates to a method that comprises depositing a high purity aluminum coating onto an aluminum article; and mechanically altering the high purity aluminum coating. In another embodiment, the method comprises mechanically altering the finish of the aluminum coating subsequent to the deposition thereof onto the aluminum article. In one embodiment, the deposition of the high purity aluminum coating onto the aluminum article is achieved using either thermal spray or cold spray prior to mechanical alteration of the finish of the aluminum article.

In one embodiment, the present disclosure relates to an aluminum article that may be produced by a method that comprises the steps of extruding an aluminum alloy to form an initial article; depositing a high purity aluminum coating onto the initial article using spray deposition; and mechanically altering the finish of the aluminum coating subsequent to the deposition thereof onto the initial article, thereby producing the aluminum article.

In yet another embodiment, the present disclosure relates to an aluminum article. In a further embodiment, the aluminum article is processed using a method that comprises the step of depositing a high purity aluminum coating onto the aluminum article using either thermal spraying or cold spraying. In another embodiment, the aluminum article is one of the following: an extruded aluminum article, a forged aluminum article, a cast aluminum article, or an aluminum rolled sheet or plate article made from the Aluminum Association's 7000 series aluminum. In a still further embodiment, the method further comprises the step of mechanically altering the finish of the aluminum coating subsequent to the deposition thereof onto the aluminum article.

The surface finishing and coating methodology according to one embodiment of the present disclosure provides an aluminum product with acceptable corrosion performance for outdoor use. An aluminum product coated and finished according to the teachings of one embodiment of the present disclosure has the desirable weight and mechanical properties of aluminum with the chosen look and performance of the high purity aluminum coating.

### BRIEF DESCRIPTION OF THE DRAWINGS

For the present disclosure to be easily understood and readily practiced, the present disclosure will now be described for purposes of illustration and not limitation, in connection with the following the FIGURE, wherein the FIGURE shows an exemplary flow chart depicting one embodiment of the present invention.

### DETAILED DESCRIPTION OF THE INVENTION

The accompanying the FIGURE and the description that follows set forth the present disclosure in embodiments of the present disclosure. However, it is contemplated that persons generally familiar with surface finishing and coating of aluminum products will be able to apply the teachings of the present disclosure in other contexts by modification of certain details. Accordingly, the FIGURE and description are not to be taken as restrictive on the scope of the present disclosure, but are to be understood as broad and general teachings. In the discussion herein, when any numerical range of values is referred, such range is understood to include each and every member and/or fraction between the stated range of minimum and maximum. The term “incidental impurities” denotes any contamination of the melt, including leaching of elements from the casting apparatus. Allowable ranges of impurities are less than 0.05 wt % for each impurity constituent and 0.15 wt % for total impurity content.

The FIGURE shows an exemplary flow chart depicting one embodiment of the present invention. In one embodiment, an aluminum article or product may be provided (block 10) for surface finishing and coating according to the teachings of the present disclosure. In another embodiment, a coating of high purity aluminum may be deposited on the aluminum article using a spray deposition technique as indicated by the exemplary block 14 in the FIGURE. Thereafter, in yet another embodiment, surface finishing may be carried out by mechanically altering the finish of the aluminum coating as indicated by the exemplary block 18 in the FIGURE. In yet another embodiment, additional surface finishing or alteration may be performed via brightening or anodizing operations as indicated by the exemplary block 22 in the FIGURE.

The present disclosure provides for applying a coating of high purity aluminum prior to performing any mechanical alterations for surface finishing. In one embodiment, the substrate to be coated and finished is composed of aluminum in order to exploit aluminum's inherent lightweight and mechanical strength properties. The material chosen for coating—i.e., a high purity aluminum—then exhibits its inherent benefits such as improved finishing ability, and enhanced durability and performance. The resultant product is therefore improved in appearance, durability (e.g., corrosion resistance), and ease of processing, but at a reduced cost.

The term “high purity” is used herein to refer to an aluminum coating that contains a minimum of 99 wt. % of aluminum by weight. In one embodiment, a high purity aluminum alloy is composed entirely of aluminum but for incidental impurities. In one embodiment, any alloy in the Aluminum Association's 1XXX series of alloys may be selected as the high purity aluminum coating according to the teachings of the present disclosure. In one embodiment, the high purity aluminum coating contains from 99.0 wt. % to about 99.2 wt. % aluminum, including but not limited to Aluminum Association 1100, 1100A, 1200, 1200A, 1300, or 1120 alloy. In another embodiment, the high purity aluminum coating contains from 99.2 wt % to about 99.5 wt. % aluminum, including but not limited to Aluminum Association 1435, 1235, 1230A, 1230, 1145, 1345, or 1445 alloy. In yet another embodiment, the high purity aluminum coating contains from 99.5 wt. % to about 99.75 wt. % aluminum, including but not limited to Aluminum Association 1150, 1350, 1350A, 1450, 1050, 1050A, 1060, 1065, 1070, 1070A and 1370 alloy. In yet a further embodiment, the high purity aluminum coating is composed of from 99.75 wt. % to about 100% aluminum, including but not limited to Aluminum Association 1080, 1080A, 1085, 1090, 1098, 1275, 1185, 1285, 1385, 1188, 1190, 1290, 1193, 1198, and 1199 alloy.

As indicated by the exemplary block 12 in the FIGURE, the aluminum article or product may have been produced using forging, casting, extrusion, or rolling. In general, any type of aluminum product may be used for the surface finishing according to the teachings of the present disclosure. In one embodiment, thermal spraying may be used as a spray deposition technique for depositing high purity aluminum coating on the aluminum article. In another embodiment, cold spraying may be used as indicated by the exemplary block 16 in the FIGURE. In one embodiment, the thickness of the high purity aluminum coating applied at block 14 (FIGURE) may range from as low as approximately 0.005″ to as high as approximately ¼″. The final thickness of the applied coating may depend on the amount of aluminum coating removed during post-coating processes including, for example, brushing, polishing, etc. (blocks 18, 20, and 22 in the FIGURE).

As indicated by the exemplary block 20 in the FIGURE, in one embodiment, the mechanical alterations that may be imparted to the aluminum coated surface may include such operations as polishing or buffing, mechanical brushing, or blasting as desired. Polishing or buffing may provide a mirror-like surface finish, brushing may provide a directional look on the surface, and blasting (e.g., via high pressure air with some hard or soft media) may be performed to provide a non-directional matte finish. It is noted here that, in one embodiment, the polished surface of the high purity aluminum coating may have a surface roughness average (Ra) finish ranging from about 2 μinches to about 6 μinches. In another embodiment, a high-purity aluminum coated aluminum sheet having a “mirror” quality may have a surface roughness average (Ra) equal to or less than 2 μinches. In another embodiment, the surface of the aluminum product to be coated may have a surface roughness average (Ra) ranging from more than or equal to about 8 μinches to less than or equal to about 32 μinches before the high purity aluminum coating operation is commenced.

After the surface finishing at blocks 18 and 20 is carried out on the aluminum product, additional surface finishing operations such as, for example, the chemical brightening or anodizing operations (block 22), also may be performed for certain aluminum alloy-based products as desired. For example, certain aluminum alloys, such as, for example, Aluminum Association's 5182, 6061, and 7075 alloys, by themselves do not anodize well. Also, extruded aluminum itself may not brighten or anodize very well. The alloying constituents in the extruded aluminum may affect the response to chemical brightening solutions and may get trapped in the anodic oxide (making it hazy or gray in appearance). However, a high purity aluminum coating according to the teachings of one embodiment of the present disclosure (block 14) may render the alloy surface more “finishable” and easy to anodize. For example, thermally spraying a high purity aluminum coating on the surface of the extruded aluminum article may facilitate a subsequent mechanical surface modification operation (e.g., polishing or brushing) to obtain the desired look and then to further perform brightening and anodizing operations. The high purity aluminum coating may react well to these chemical (e.g., brightening) and electrochemical (e.g., anodizing) processes.

Referring now to the exemplary block 12 in the FIGURE, it is noted that an extruded aluminum article may be light weight, allowing it to be useful, for example, in automotive or aerospace applications to achieve greater fuel efficiency. In one embodiment, aluminum extrusions are carried out by providing a billet of an aluminum extrusion alloy. The billet may be homogenized or pre-heated to a high temperature prior to extrusion. Thereafter, the metal billet may be pressed through an extrusion die (which can be a solid or a hollow die) having a profile configured to provide the desired shape for the extruded product. The extrusion process may be either a direct, an indirect, or a continuous extrusion process. In one embodiment, deposition of high purity aluminum (block 14 in the FIGURE) may occur in the production line, known as in-line, after the extruded aluminum product exits the extrusion die (i.e., immediately after extruding, but before the extrusion is cut to length). In another embodiment, the deposition may be performed after the extruded product goes through a tempering operation (e.g., sawed or stretched).

In one embodiment, an aluminum alloy that can be selected for extrusion and subsequent high purity aluminum coating and surface finishing may include the Aluminum Association's 6060, 6061, and 6063 aluminum alloys. In one embodiment, the chemical composition of the 6060 alloy may include, by weight percentage, about 0.3 to about 0.6% of silicon (Si), about 0.1 to about 0.3% of iron (Fe), less than 0.1% of copper (Cu), less than 0.1% of manganese (Mn), about 0.35 to about 0.6% of magnesium (Mg), less than 0.05% of chromium (Cr), less than 0.15% of zinc (Zn), less than 0.1% of titanium (Ti), a total of about 0.15% of other metallic elements (e.g., nickel (Ni), germanium (Ga), etc.) with each metallic element not more than 0.05%, and aluminum constituting the remainder of the percentages. In another embodiment, the chemical composition of the 6061 alloy may include, by weight percentage, about 0.4 to about 0.8% of silicon (Si), less than about 0.7% of iron (Fe), about 0.15 to about 0.4% of copper (Cu), less than about 0.15% of manganese (Mn), about 0.8 to about 1.2% of magnesium (Mg), about 0.04 to about 0.35% of chromium (Cr), less than about 0.25% of zinc (Zn), less than about 0.15% of titanium (Ti), a total of about 0.15% of other metallic elements (e.g., nickel (Ni), germanium (Ga), etc.) with each metallic element not more than about 0.05%, and aluminum constituting the remainder of the percentages. In yet another embodiment, the chemical composition of the 6063 aluminum alloy may include, by weight percentage, about 0.2 to about 0.6% of silicon (Si), less than about 0.35% of iron (Fe), less than about 0.1% of copper (Cu), less than about 0.1% of manganese (Mn), about 0.45 to about 0.9% of magnesium (Mg), less than about 0.1% of chromium (Cr), less than about 0.1% of zinc (Zn), less than about 0.1% of titanium (Ti), a total of about 0.15% of other metallic elements (e.g., nickel (Ni), germanium (Ga), etc.) with each metallic element not more than about 0.05%, and aluminum constituting the remainder of the percentages.

Some examples of extruded aluminum products that may be selected for high purity aluminum deposition and surface finishing as per the teachings of the present disclosure may include panels used in transportation applications (e.g., a car bright accent trim, automotive bumpers, etc.), panels used in horse trailers or carriages (e.g., trailer doors or extruded horse trailer exteriors), panels used in a dump truck body, panels used in refrigeration trucks (e.g., enclosures for the refrigeration compartment) that provide mobile refrigeration during product transport, etc. In one embodiment, extruded door and window frames (e.g., for use in residential applications) may also be selected for high purity aluminum coating and surface finishing as per the teachings of the present disclosure.

As noted earlier with reference to the exemplary block 12 in the FIGURE, the spray deposition-based high purity aluminum coating methodology according to one embodiment of the present disclosure may also be employed for non-extruded aluminum products or articles such as, for example, forged aluminum products, cast aluminum products, or rolled aluminum products. In one embodiment, the forged aluminum product may be a forged aluminum wheel. In another embodiment, a cast aluminum wheel may be used for high purity aluminum coating thereon. In yet another embodiment, an aluminum rolled sheet or plate article made from the Aluminum Association's 7000 series aluminum may also be used. In a further embodiment, the rolled aluminum articles are aluminum bumpers used in automotive applications.

in one embodiment, the high purity aluminum coating (block 14, the FIGURE) and subsequent surface finishing (block 18, the FIGURE) may be performed on an aluminum article—whether extruded, forged, cast, or rolled—that is made of an aluminum alloy selected from the Aluminum Association's 1XXX, 2XXX, 3XXX, 4XXX, 5XXX, 6XXX, 7XXX, and 8XXX series of aluminum alloys.

Referring now to the exemplary block 16 in the FIGURE, it is observed that the high purity aluminum coating may be deposited on the aluminum article using thermal spraying or cold spraying. The term “thermal spraying” refers to a group of coating processes in which finely divided metallic or non-metallic materials are deposited in a molten or semi-molten condition to form a coating. In one embodiment, the coating material—i.e., the high purity aluminum—may be in the form of powder, wire, or molten material. In case of thermal spraying, a number of deposition techniques may be used. In one embodiment, the heating source for a thermal spraying technique may be an oxy-fuel or flame source. In another embodiment, electrical energy may be used as a heat source. Some exemplary thermal spraying techniques include, for example, high velocity oxygen fuel (HVOF) thermal spray, detonation thermal spray, low velocity combustion thermal spray, powder (e.g., metallic) or molten metal thermal spray, plasma (non-transferred arc plasma or RF plasma) thermal spray, and twin wire arc thermal spray. In one embodiment, prior to deposition of the high purity aluminum coating via thermal spraying, the aluminum article may be heated to substantially minimize crack formation that may result from thermally induced stresses produced by differences in the coefficients of expansion between the article and the coating.

Cold spraying is a kinetic spray process utilizing supersonic jets of compressed gas to accelerate near-room temperature powder particles (here, of high purity aluminum) at high velocities, wherein the particles traveling at speeds between about 450 to 1,500 m/sec impact with the substrate (here, the aluminum article or product being coated with high purity aluminum) to create a coating. In one embodiment, the particles plastically deform and consolidate on the substrate upon impact. Cold spray may also be referred to as gas dynamic spray, supersonic spray, and/or kinetic spray. The basis of the cold spray process is the gas-dynamic acceleration of particulates (here, of high purity aluminum) to supersonic velocities (450-1500 m/sec), and hence high kinetic energies, so that solid-state plastic deformation and fusion occur on impact to produce dense coatings without the feedstock material (here, the high purity aluminum to be applied as a coating) being significantly heated. In one embodiment, this may be achieved using convergent-divergent de Laval nozzles, high pressures (up to 500 psi or 3.5 MPa) and flow rates (up to 90 m³/hr) of compressed gases such as helium or nitrogen. In another embodiment, the gases may be pre-heated to about 800° C. (1472° F.), or below the melting point of many metals, to increase the velocity of the particles of the coating material. In one embodiment, the particles of the metallic bonding material (here, the high purity aluminum) may have a particle diameter ranging from about 1 to about 50 microns, and a particle density ranging from about 2.5 g/cm³ to about 20 g/cm³.

In one embodiment, the spray deposition (e.g., thermal spraying) at block 14 in the FIGURE may be performed in an inert atmosphere, such as in argon, in order to prevent the oxidation of the aluminum product that is to be sprayed. In such an embodiment, the aluminum product (e.g., an extruded aluminum product) may be taken away from the manufacturing line and placed in an air-tight chamber having an inert atmosphere. In other words, such inert atmosphere-based spray deposition may not be performed in-line. On the other hand, in another embodiment, the spray deposition may be performed in air (e.g., in the room atmosphere), thereby allowing the spraying process (thermal or cold spraying) to occur in a continuous, in-line fashion (i.e., without the aluminum product leaving the manufacturing line). An in-line spraying process may reduce the total amount of time and cost associated with the manufacture of the high purity aluminum-coated product according to the teachings of one embodiment of the present disclosure.

The foregoing describes a surface finishing and coating methodology that provides a superior looking aluminum product with acceptable corrosion performance for outdoor use. In one embodiment, a coating of high purity aluminum is applied first to an aluminum article or product via cold or thermal spray, and the mechanical surface modification (e.g., polishing, buffing, brushing, etc.) is done second. The resulting product has the desirable light weight and mechanical properties of aluminum with the chosen look and performance of the high purity aluminum coating. The aluminum product to be coated may be obtained by extrusion, forging, casting, or rolling.

Though the above description illustrates aluminum as the base metal and metallic spray coating, all other alloys are contemplated within the scope of the invention, such as but not limited to nickel, steel, iron, and combinations thereof.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A method for forming a coating upon an article comprising the steps of:
(a) providing the article formed from an alloy of a base metal having a surface with a predetermined surface roughness;
(b) cold metal spraying a layer to a predetermined thickness onto a portion of the surface of the article to form the coating; and
(c) anodizing the article.

2. The method according to claim 1 wherein the base metal of the article is an aluminum alloy.

3. The method according to claim 1 wherein the layer is an aluminum alloy.

4. The method according to claim 1 further comprising a step of polishing the layer to a predetermined surface roughness after step (b) to form a polished surface.

5. The method according to claim 3 wherein the aluminum alloy is a high purity aluminum.

6. The method according to claim 1 further comprising a step of forming before the step (a).

7. The method according to claim 1 wherein the step (b) is performed in the production line.

8. The method according to claim 6 further comprising a step of tempering after the step (a).

9. The method according to claim 5 wherein the high purity aluminum is an Aluminum Association's 1XXX series alloy.

10. The method according to claim 9 wherein the Aluminum Association's 1XXX series alloy comprises from about 99.0 wt. % to 99.2 wt. % aluminum.

11. The method according to claim 9 wherein the Aluminum Association's 1XXX series alloy comprises from about 99.5 wt. %) to 99.75 wt. % aluminum.

12. The method according to claim 9 wherein the Aluminum Association's 1XXX series alloy comprises from about 99.75 wt. % to 100.0 wt. % aluminum.

13. The method according to claim 1 wherein the layer predetermined thickness ranging from about 0.005 to about 0.25 inches.

14. The method according to claim 4 wherein the layer predetermined surface roughness comprises a surface roughness average (Ra) finish ranging from about 2 to about 6 μinches.

15. The method according to claim 4 wherein the layer predetermined surface roughness comprise a surface roughness average (Ra) finish less than about 2 μinches.

16. The method according to claim 1 wherein the predetermined surface roughness of the surface of the article comprising a surface roughness average (Ra) finish ranging from about 8 to about 32 μinches before the step (b).

17. The method according to claim 2 wherein the aluminum alloy of the base metal of the article is selected from the group consisting 1XXX, 2XXX, 3XXX, 4XXX, 5XXX, 6XXX, 7XXX, and 8XXX.

18. The method according to claim 6 wherein the step of forming is extrusion.

19. The method according to claim 1 further comprising a step of cutting the article to length after the step (b).

20. An anodically coated metal article comprising:
an article formed from an alloy of a base metal having a surface;
a cold sprayed metallic layer disposed onto a portion of the surface of the article to form a coating, wherein the coating being anodized to form the anodically coated metal article.

21. The anodically coated metal article according to claim 20 wherein the anodically coated metal article being one of the following: an extruded aluminum article; a forged aluminum article; a cast aluminum article; or high strength aluminum rolled sheet or plate article.

22. The anodically coated metal article according to claim 21 wherein the extruded aluminum article is one of the following:
a panel used in a transportation application;
a panel used in a horse trailer;
a panel used in a dump truck body; or
a panel used in a refrigeration truck.

23. The anodically coated metal article according to claim 21 wherein the forged aluminum article is a forged aluminum wheel.

24. The anodically coated metal article according to claim 21 wherein the cast aluminum article is a cast aluminum wheel.

25. The anodically coated metal article according to claim 21 wherein the high strength aluminum rolled sheet or plate article is an aluminum bumper made from the Aluminum Association's 7000 series aluminum.
